(19) United States
(12) Patent Application Publication
(10) Pub. No.: US 2026/0169997 A1
(43) Pub. Date: Jun. 18, 2026

(54) METHOD, APPARATUS, DEVICE, STORAGE MEDIUM AND PROGRAM PRODUCT FOR REQUEST PROCESSING

(71) Applicant: Beijing Zitiao Network Technology Co., Ltd., Beijing (CN)

(72) Inventors: Xujie Tao, Beijing (CN); Jia Guo, Beijing (CN); Mengqian Liu, Beijing (CN); Shuo Liu, Beijing (CN)

(21) Appl. No.: 19/349,933

(22) Filed: Oct. 3, 2025

(30) Foreign Application Priority Data
Dec. 13, 2024 (CN) 202411844964.4

(51) Int. Cl. G06F 16/2458

(52) U.S. Cl. CPC G06F 16/2462

(57) ABSTRACT

The disclosure provides a method, apparatus, device, storage medium and program product for request processing. The method includes: obtaining query data related to a query request, the query data including at least one type of query data; determining, for each type in the at least one type, a sampling strategy corresponding to the query data of the type, from a plurality of sampling strategies, based on the query request; separately sampling the at least one type of query data based on the determined sampling strategy, to obtain at least one type of sampled query data; and determining, based on the query request and the at least one type of sampled query data, a reply for the query request, by using a trained first machine learning model.

### CROSS REFERENCETO RELATED APPLICATION

The present application claims priority to Chinese Patent Application No. 202411844964.4, filed on December 13, 2024, entitled “METHOD, APPARATUS, DEVICE, STORAGE MEDIUM AND PROGRAM PRODUCT FOR PROCESSING REQUEST”, which is incorporated herein by reference in its entirety.

### FIELD

The example embodiments of the present disclosure relate to the field of computers, and in particular, to a method, an apparatus, an electronic device, a computer-readable storage medium and a computer program product for request processing.

### BACKGROUND

With the development of information technology, various terminal devices may provide people with various services in work and life. For example, applications that provide services may be deployed in the terminal devices. The terminal devices or the applications may provide users with reply functions for user query requests, to assist the users in using the terminal devices or the applications. The terminal devices may receive query requests for queries, execute the query requests to determine replies to the query requests, and provide the replies to the users.

### SUMMARY

In a first aspect of the present disclosure, a method of request processing is provided. The method comprises: obtaining query data related to a query request, the query data including at least one type of query data; determining, for each type of the at least one type, a sampling strategy corresponding to the query data of the type, from a plurality of sampling strategies, based on the query request; separately sampling the at least one type of query data based on the determined sampling strategy, to obtain at least one type of sampled query data; and determining, based on the query request and the at least one type of sampled query data, a reply for the query request, by using a trained first machine learning model.

In a second aspect of the present disclosure, an apparatus for processing a task is provided. The apparatus comprises: a query data obtaining module configured to obtain query data related to a query request, the query data including at least one type of query data; a sampling strategy determining module configured to determine, for each type of the at least one type, a sampling strategy corresponding to the query data of type, from a plurality of sampling strategies, based on the query request; a sampled query data obtaining module configured to separately sample the at least one type of query data based on the determined sampling strategy, to obtain at least one type of sampled query data; and a reply determining module configured to determine, based on the query request and the at least one type of sampled query data, a reply for the query request by using a trained first machine learning model.

In a third aspect of the present disclosure, an electronic device is provided. The electronic device comprises at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The medium stores a computer program, and when the computer program is executed by the processor, the method in the first aspect is implemented.

In a fifth aspect of the present disclosure, a computer program product is provided. The product comprises a computer program, wherein the computer program, when executed by a processor, implements the method according to the first aspect of the present disclosure.

It should be understood that the contents described in this section are not intended to limit the key features or important features of the present disclosure, nor are they intended to limit the scope of the present disclosure. Other features of the present disclosure will become readily understood from the following description.

### BRIEF DESCRIPTION OF DRAWINGS

The above and other features, advantages, and aspects of each embodiment of the present disclosure will become more apparent in conjunction with the accompanying drawings and with reference to the following detailed description. In the drawings, the same or similar reference numerals indicate the same or similar elements, where:

FIG. 1 illustrates a schematic diagram of an example environment in which embodiments of the present disclosure can be implemented;

FIGS. 2A to 2D illustrate schematic diagrams of example architectures for request processing according to some embodiments of the present disclosure;

FIG. 3A to FIG. 3D are schematic diagrams of example architectures for obtaining a dataset for training a machine learning model according to some embodiments of the present disclosure;

FIG. 4 illustrates a flowchart of a method of request processing according to some embodiments of the present disclosure;

FIG. 5 illustrates a schematic structural block diagram of an example apparatus for request processing according to some embodiments of the present disclosure; and

FIG. 6 illustrates a block diagram of an example electronic device in which one or more embodiments of the present disclosure may be implemented.

### DETAILED DESCRIPTION

Embodiments of the present disclosure will be described in more detail below with reference to the accompanying drawings. Although some embodiments of the present disclosure are shown in the drawings, it would be appreciated that the present disclosure can be implemented in various forms, and should not be interpreted as limited to the embodiments described herein. On the contrary, these embodiments are provided for a more thorough and complete understanding of the present disclosure. It would be appreciated that the drawings and embodiments of the present disclosure are only for illustrative purposes and are not intended to limit the scope of protection of the present disclosure.

In the description of the embodiments of the present disclosure, the terms “including” and similar terms should be understood as open-ended inclusion, that is, “including but not limited to”. The term “based on” should be understood as “at least partially based on”. The terms “one embodiment” or “the embodiment” should be understood as “at least one embodiment”. The term “some embodiments” should be understood as “at least some embodiments”. Other explicit and implicit definitions may also be included below.

Unless expressly stated, performing a step “in response to A” does not mean that the step is performed immediately after “A”, but may include one or more intermediate steps.

It is to be understood that data involved in the present technical solution (including but not limited to the data itself, the acquisition, use, storage or deletion of the data) should comply with requirements of corresponding laws and regulations and relevant rules.

It is to be understood that, before applying the technical solutions disclosed in various embodiments of the present disclosure, the relevant user should be informed of the type, scope of use, and use scenario of the personal information involved in the subject matter described herein in an appropriate manner in accordance with relevant laws and regulations, and user authorization should be obtained.

For example, in response to receiving an active request from the user, prompt information is sent to the user to explicitly inform the user that the requested operation would acquire and use the user’s personal information. Therefore, according to the prompt information, the user may decide on his/her own whether to provide the personal information to the software or hardware, such as electronic devices, applications, servers, or storage media that execute operations of the technical solutions of the subject matter described herein.

As an optional, but non-limiting, embodiment, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the embodiments of the present disclosure. Other methods that satisfy relevant laws and regulations are also applicable to the embodiments of the present disclosure.

As used herein, the term “model” may learn the correlation relationship between corresponding inputs and outputs from training data, so that corresponding outputs may be generated for given inputs after training. The generation of the model may be based on machine learning technology. Deep learning is a machine learning algorithm that processes inputs and provides corresponding outputs by using a plurality of layers of processing units. Neural network model is an example of deep learning-based model. The term “model” may also be referred to as “machine learning model”, “learning model”, “machine learning network”, or “learning network”, and these terms are used interchangeably herein.

A “neural network” is a machine learning network based on deep learning. The neural network is capable of processing inputs and providing corresponding outputs, typically including an input layer and an output layer and one or more hidden layers between the input layer and the output layer. Neural networks used in deep learning applications typically include many hidden layers to increase the depth of the network. Each layer of the neural network is connected in order so that the output of a previous layer is provided as an input to a next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may include three stages, a training stage, a testing stage, and an application stage (also referred to as an inference stage). During the training stage, a given model may be trained using a large amount of training data, iteratively updating the parameter values, until the model is able to obtain consistent inferences that satisfy expected objectives from the training data. By training, the model may be considered capable of learning an association between the input and the output(also referred to as input-output mapping) from the training data . The parameter values of the trained model are determined. In the testing stage, the test input is applied to the trained model to test whether the model may provide the correct output, thereby determining performance of the model. The testing stage may sometimes be fused in a training stage. In the application or inference stage, the trained model may be used to process an actual model input based on the parameter values obtained by training, to determine a corresponding model output.

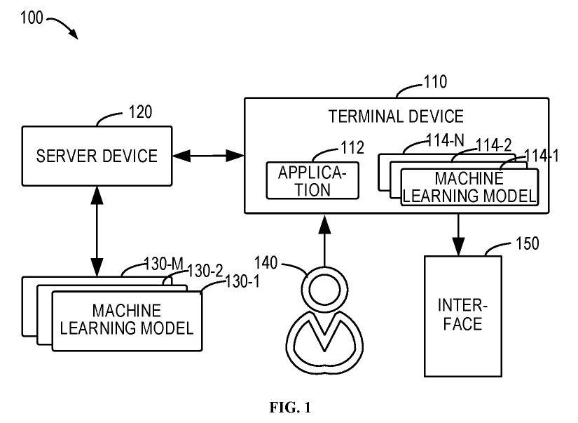

FIG. 1 illustrates a schematic diagram of an example environment 100 in which embodiments of the present disclosure can be implemented. In this example environment 100, an application 112 is installed in a terminal device 110. A user 140 may interact with the application 112 via the terminal device 110 and/or an attachment device of the terminal device 110. For example, the application 112 may collect speech of the user 140 through a speech acquisition component (such as a microphone) of the terminal device 110, collect an image or video of the user 140 through an image acquisition component (such as a camera) of the terminal device 110, collect posture information of the user 140 through a sensor (such as a gyroscope) of the terminal device 110, and the like.

In an embodiment of the present disclosure, the application 112 may be any suitable application having a request processing function. For example, the application 112 may be a social application, a chat application, a media item application, and so on. In some embodiments, the application 112 may provide a digital assistant for human-computer dialogue. The digital assistant supports text dialogue services, speech dialogue services, and content dialogue under other modalities with the user 140. In some embodiments, the application 112 or the digital assistant of the application 112 may utilize a machine learning model to assist in providing one or more services. For example, the application 112 or the digital assistant of the application 112 may utilize a machine learning model to provide a question and answer service to the user 140. The reply of digital assistant to the user may be determined based on a model output of the machine learning model.

In some embodiments, one or more machine learning models 114-1, 114-2, …, 114-N (collectively or individually referred to as machine learning model 114) may be deployed locally on the terminal device 110. These machine learning models 114 may be configured to determine or assist in determining replies to the users. In some embodiments, one or more machine learning models 130-1, 130-2, …, 130-M (collectively or individually referred to as machine learning model 130) may also be deployed on a server device 120. These machine learning models 130 may also be configured to determine or assist in determining replies to the users.

Both machine learning model 114 and 130 may be based on any suitable model structure, including but not limited to a Transformer model, a convolutional neural network (CNN), a recurrent neural network (RNN), a deep neural network (DNN), and so on. In some embodiments, the one or more machine learning models 114 and/or the machine learning models 130 may be based on a language model (LM), a multimodal language model, and so on. The language model may have question and answer capability by learning from a large amount of corpus. The multimodal language model may support processing of data (e.g., text, audio, image, video, sensor data, etc.) for multiple modalities.

In some embodiments, the language model-based machine learning model may receive model inputs in text modality (e.g., natural language and/or machine language) and/or non-text modality (e.g., image, speech, video, etc.), and may generate desired output based on the model input and prompt. The prompt here is used to guide the machine learning model to generate a model output capable of solving a requirement of the user indicated by the model inputs. In an application scenario for supporting a user dialogue, the input of the user 140 may be provided as at least a portion of the model input (other portions may include the prompt) to the machine learning model 114 and/or the machine learning model 130.

It should be noted that both the machine learning model 114 and the machine learning model 130 may include one or more machine learning models. If multiple machine learning models are included, functions, structures, uses, etc. of these machine learning models may be the same or different.

In environment 100, if the application 112 is in an active state, the terminal device 110 may present a user interface (e.g., interface 150) of the application 112. The interface 150 may include various interfaces that may be provided by the application 112, such as a dialogue interface between the user and the digital assistant (which may present a current dialogue and a historical dialog, including text dialogue content), and so on. In some embodiments, the terminal device 110 may play speech via the interface 150, and the speech may include question speech from the user and reply speech for the question speech.

In some embodiments, the terminal device 110 communicates with the server device 120 to enable service provisioning for the application 112. For example, the server device 120 may invoke the machine learning model 130 to support a human-computer dialogue function between the application 112 and the user 140 based on the output of the machine learning model 130.

The terminal device 110 may be any type of mobile terminal, stationary terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuits, etc.).

The server device 120 may be a standalone physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 120 may include, for example, a computing system/server, such as a mainframe, an edge computing node, a computing device in a cloud environment, and the like. The server device 120 may be implemented, for example, based on a cloud environment.

It should be understood that the structure and functionality of environment 100 are described for illustrative purposes only, without implying any limitation on the scope of the present disclosure.

As mentioned above, the terminal device may receive a query request for the query, perform the query request to determine a reply for the query request, and provide the reply to the user. Conventionally, data related to query may be processed by using a multimodal model, including user query requests and other related query data for determining replies, such as image, audio, video, sensor measurement data related to a contextual environment, and the like. Usually, the collected high-resolution and densely sampled original query data are provided directly to the model for processing. Although this enables the model to capture more details, it significantly increases computational complexity, device energy consumption, and data transmission amount.

Further, the problem of limited computing resources can be solved by deploying and running the machine learning models locally, or by combining locally deployed machine learning models with machine learning models on server device. However, in the case of locally deployed machine learning models, excessive data impose higher demands on local computing resources and device energy consumption. In scenarios where the machine learning models on the server device are used collaboratively, excessive data may also reduce inference speed of the machine learning model at the server device. In addition, the model is required to process high-resolution data is also a challenge for the training process of the model.

In view of this, according to an embodiment of the present disclosure, an improved solution for request processing is provided. According to the solution of the embodiments of the present disclosure, query data related to a query request is obtained, and the query data includes at least one type of query data. Further, for each type of the at least one type, a sampling strategy corresponding to the query data of the type is determined from a plurality of sampling strategies, based on the query request. The at least one type of query data is separately sampled based on the determined sampling strategy, to obtain at least one type of sampled query data. Then, based on the query request and the at least one type of sampled query data, a reply for the query request is determined by using a trained first machine learning model.

In this way, an appropriate sampling strategy for the query data may be dynamically determined based on the current query request, and the sampling strategy may be determined as ensuring quality of the reply to the query request while reducing the data amount. In this way, when determining the reply, the machine learning model only needs to process the downsampling query data instead of the original query data, which can optimize the inference efficiency of the machine learning model, improve the reply speed of the query request to the user, thereby enhancing the user experience. Less data processing can also reduce device energy consumption. In addition, as the sampling strategy is flexibly determined for different query requests, the influence on the quality of reply generation for the query request may be mitigated as much as possible.

Some example embodiments of the present disclosure will be described below with reference to the accompanying drawings.

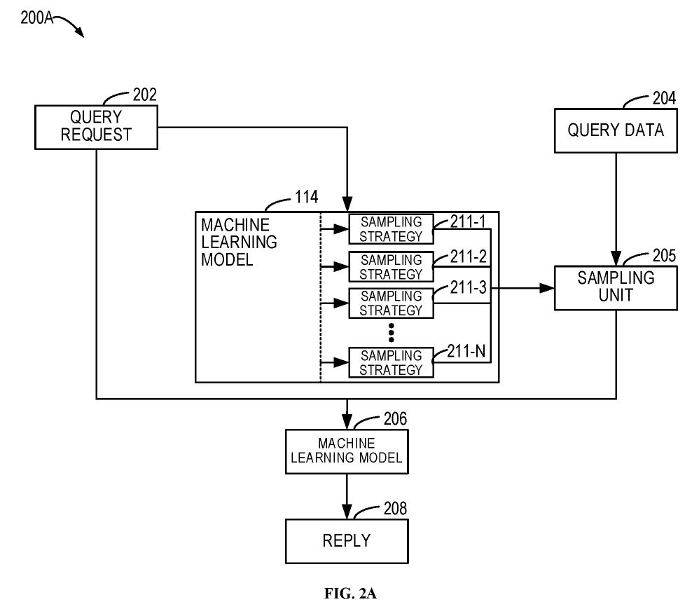

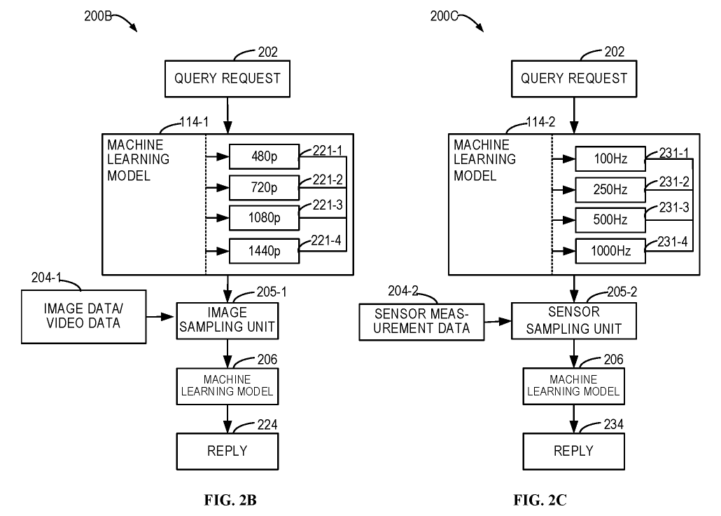

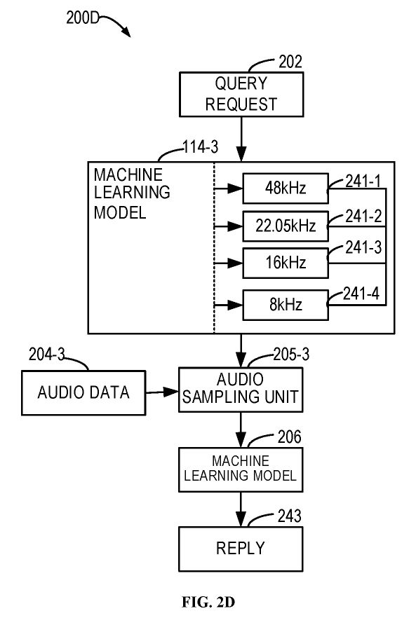

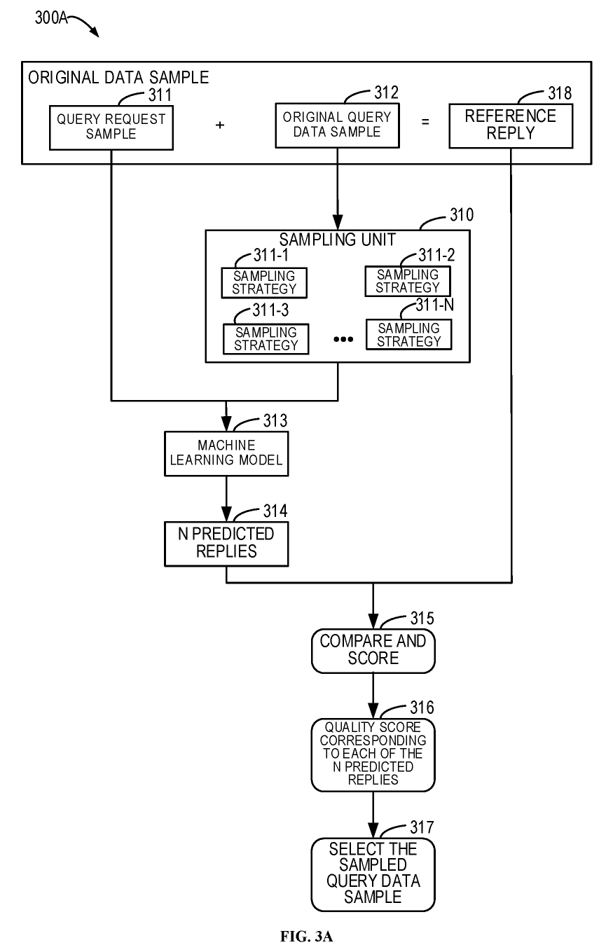

FIGS. 2A to 2D illustrate schematic diagrams of example architectures 200A-200D for request processing according to some embodiments of the present disclosure. The example architectures 200A-200D may be implemented at the terminal device 110. For ease of discussion, the example architectures 200A-200D will be described with reference to the environment 100 of FIG. 1. It should be noted that the operations performed by the terminal device 110 mentioned above and the operations performed by the terminal device 110 described subsequently may be performed by relevant application programmers (such as the application 112) installed on the terminal device 110. In some embodiments, the operations performed on the terminal device 110 may be completed with the assistance of the server device 120.

Hereinafter, an application scenario of the present disclosure will be described with reference to the examples. If the terminal device 110 receives a query request (such as a question and answer request) input by the user 140 and query data (such as an image, a video, audio, and the like) related to the user query request, the terminal device 110 may provide the user 140 with a reply corresponding to the query request. For example, if the terminal device 110 receives the information “please help me summarize the main content in the video A” from the user 140, the terminal device 110 may provide the user 140 with a reply to the query request. The above example scenario is merely illustrative, which is not limited in the present disclosure. How the terminal device 110 efficiently provides a reply to the query request to the user is described in detail below with reference to FIGS. 2A-2D.

In an embodiment of the present disclosure, the terminal device 110 obtains query data related to the query request, wherein the query data includes at least one type of query data. Referring to the example architecture 200A shown in FIG. 2A, the terminal device 110 may obtain a query request 202 input by the user 140 and query data 204 related to the query request 202.

In some embodiments, the terminal device 110 may receive a query request 202 from a user (e.g., user 140) in any suitable manner. For example, the terminal device 110 may receive a query request 202 in the form of a speech input by the user 140 via a microphone. The terminal device 110 may receive a query request 202 in the form of text input by the user 140 via an input box. In some embodiments, the query request 202 may include a user question for the digital assistant. The terminal device 110 receives a user question during interaction between the user and the digital assistant.

In an embodiment of the present disclosure, for different types of query data, a plurality of optional sampling strategies may be configured, and an appropriate sampling strategy may be selected each time based on the query request. In some embodiments, the plurality of sampling strategies may be configured to sample different data amounts from the query data. The plurality of sampling strategies may be configured based on the type of query data. Referring to FIG. 2A, the query data 204 related to the query request 202 may be query data of an image type, such as image data 204-1. The query data 204 related to query request 202 may be query data of a video type, such as video data 204-1. The query data 204 related to the query request 202 may also be query data of an audio type, such as audio data 204-3. The query data 204 related to the query request 202 may also be query data of a measurement data type, such as sensor measurement data 204-2 obtained via an inertial measurement unit (IMU). It can be understood that data such as image data/video data 204-1, sensor measurement data 204-2, audio data 204-3, etc. may be collectively or individually referred to as query data 204.

In some embodiments, when the query data 204 includes image data of the image type or video data of the video type, the plurality of sampling strategies may indicate a plurality of resolutions. As shown in the example architecture 200B of FIG. 2B, when the query data 204 includes image data of the image type or video data of the video type, the plurality of resolutions for determining the sampling strategy of the query data of the image type/video type may include 480P (as shown by 221-1 in FIG. 2B), 720P (as shown by 221-2 in FIG. 2B), 1080P (as shown by 221-3 in FIG. 2B), 1440P (as shown by 221-4 in FIG. 2B), and the like.

In some embodiments, when the query data 204 includes video data of the video type, a sampling strategy for determining query data of the video type may also indicate a sampling interval. For example, the terminal device 110 may divide the query data of the video type into X parts, and randomly select one frame for each part. The terminal device 110 may further extract one frame at intervals of X frames in consecutive frames.

In other embodiments, when the query data 204 includes audio data or measurement data of sensor measurement data type, the plurality of sampling strategies may indicate a plurality of sampling frequencies. As shown in the example architecture 200C of FIG. 2C, when the query data 204 includes measurement data of the sensor measurement data type, the plurality of sampling frequencies for determining the sampling strategy of the sensor measurement data 204-2 may include, for example, a sampling frequency of 100 Hz (as shown by 231-1 in FIG. 2C), 250 Hz (as shown by 231-2 in FIG. 2C), 500 Hz (as shown by 231-3 in FIG. 2C), 1000 Hz (as shown by 231-4 in FIG. 2C), and the like. As shown in the example architecture 200D of FIG. 2D, when the query data 204 includes audio data of the audio type, the plurality of sampling frequencies for determining the sampling strategy of the audio data 204-3 may include, for example, a sampling frequency of 48 kHz (as shown by 241-1 in FIG. 2D), 22.05 kHz (as shown by 241-2 in FIG. 2D), 16 kHz (as shown by 241-3 in FIG. 2D), and 8kHz (as shown by 241-4 in FIG. 2D) , and the like.

In some embodiments, one of the plurality of sampling strategies may indicate that downsampling is not performed on the query data. Other sampling strategies of the plurality of sampling strategies may indicate a lower resolution than the original resolution of the query data (for images or video), or a lower sampling frequency than a default sampling frequency (for audio or sensor measurement data). These sampling strategies may indicate a downsampling strategy for the query data, thereby reducing the data amount to be transmitted to a subsequent machine learning model. In some embodiments, each of the plurality of sampling strategies may include a lower resolution than the original resolution of the query data (for images or video), or a lower sampling frequency than the default sampling frequency (for audio or sensor measurement data).

Depending on the type of the query data, the terminal device 110 determines, based on the query request, a sampling strategy corresponding to the query data of the type from a plurality of sampling strategies applicable to that type. In some embodiments, a trained machine learning model (referred to as a “second machine learning model”) may be utilized to determine corresponding sampling strategies for different types of query data. Referring to the example architecture 200A shown in FIG. 2A, for each type of query data 204, the terminal device 110 may determine, based on the query request 202, a sampling strategy corresponding to the query data 204 of the type, from the sampling strategies 211-1, 211-2,··· 211-N (collectively or individually as sampling strategy 211), by using the trained machine learning model 114. For example, the terminal device 110 may determine a sampling strategy corresponding to the query data 204 (such as image A) related to the query request 202, based on the query request 202 (for example, please help me summarize the main content of image A) input by the user 140. For example, the terminal device 110 may determine that the sampling strategy for image A is to downsample image A to 720p.

In some embodiments, for different types of query data, different machine learning models 114 may be pretrained to determine sampling strategies for the corresponding types of query data. The terminal device 110 may determine a sampling strategy corresponding to the query data of the type from a plurality of sampling strategies in the following way. Specifically, the terminal device 110 determines a machine learning model 114 corresponding to a given type of the at least one type. Correspondingly, the terminal device 110 determines, based on the query request, the sampling strategy corresponding to the query data of the given type from the plurality of sampling strategies of the given type, by using the determined machine learning model 114.

It may be understood that the terminal device 110 may invoke a machine learning model corresponding to each type of query data to determine a sampling strategy corresponding to each type of query data. For example, for the query data of the image type, the terminal device 110 may invoke machine learning model A to determine a sampling strategy corresponding to the query data of the image type. For the query data of the sensor measurement data type, the terminal device 110 may invoke machine learning model B to determine a sampling strategy corresponding to the query data of the sensor measurement data type. For the query data of the audio data type, the terminal device 110 may invoke the machine learning model C to determine a sampling strategy corresponding to the query data of the audio data type. In some other embodiments, for at least one type of query data, the terminal device 110 may separately determine a sampling strategy corresponding to the at least one query data by invoking a machine learning model.

In some embodiments, the machine learning model 114 may be deployed locally in the terminal device 110 to determine the sampling strategy for the query data. Since the machine learning model 114 only needs to perform classification among the plurality of sampling strategies to determine the sampling strategy that matches the current query request, the model size of such machine learning models is usually not too large, which is suitable for running locally on the terminal device without occupying too many resources. In addition, in some embodiments, by using the machine learning model 114 to determine the downsampling strategy for the query data, the data amount to be transmitted to the subsequent machine learning model 130 can be reduced. In this way, the inference speed of the subsequent machine learning model can be improved, and the inference overhead can be reduced. If the subsequent machine learning model 130 is deployed on the server device instead of the terminal device, the network overhead can be further reduced and the data transmission speed can be improved by reducing the data amount to be transmitted via the network in advance on the local terminal device, thereby further improving the reply efficiency of the query requests.

In an embodiment of the present disclosure, the terminal device 110, based a sampling strategy, samples at least one type of query data separately, to obtain at least one type of sampled query data. In some embodiments, the terminal device 110 uses the machine learning model 114 to determine a sampling strategy of a specific type of query data from a plurality of sampling strategies. Subsequently, the terminal device 110 may sample the query data 204 by invoking the sampling unit 205 based the sampling strategy determined by the terminal device 110, to determine at least one type of sampled query data.

For example, when the terminal device 110 determines that the sampling strategy of image A is to downsample image A to 720p, the terminal device 110 may send the sampling strategy as an instruction to the sampling unit 205. Correspondingly, after receiving the instruction, the sampling unit 205 may downsample the received image A to 720p.

In the embodiment of the present disclosure, the terminal device 110 determines a reply to the query request using the trained machine learning model 130, based on the query request and the at least one type of sampled query data. Referring to FIG. 2A, the terminal device 110 may determine the reply 208 for the query request 202 using the machine learning model 206, based on the query request 202 and the sampled query data.

With continued reference to the above example, the terminal device 110 sends, to the machine learning model 206, the downsampled 720p image obtained by the sampling unit 205 and the query request 202 (for example, please help me summarize the main content in image A). Subsequently, the terminal device 110 receives a reply 208 for the query request determined by the machine learning model 206. It should be understood that the machine learning model 206 may be the machine learning model 114 deployed locally on the terminal device 110, or may be a machine learning model 130 deployed on the server device 120.

In some embodiments, if the machine learning model 206 is deployed on the server device, the terminal device 110 may send the query request and the sampled query data to the server device. The server device provides the query request and the sampled query data to the machine learning model 130 for determining the model output. The server device may determine the reply based on the model output and process the request to the terminal device, or the server device may provide the model output to the terminal device, and the terminal device determines the reply.

In some embodiments, sampling of the query data may also be implemented at the server device. After determining the sampling strategy, the terminal device may send the determined sampling strategy, the query request, and the query data to the server device. The server device may sample the query data based on the sampling strategy, and provide the sampled query data and the query request to the machine learning model 206 for determining the model output.

For ease of understanding, the following describes that the terminal device 110 determines the reply to the query request with reference to FIG. 2B to FIG. 2D and some examples.

Referring to the example architecture 200B shown in FIG. 2B, it is described that the terminal device 110 determines a reply to the query request with the scenario where the query data 204 is of the image type. When the query data 204 includes image data of the image type or video data of the video type, the plurality of resolutions for determining the sampling strategy of the query data of the image type/video type may include 480P (as shown by 221-1 in FIG. 2B), 720P (as shown by 221-2 in FIG. 2B), 1080P (as shown by 221-3 in FIG. 2B), 1440P (as shown by 221-4 in FIG. 2B), and on the like. Of course, it should be understood that only several examples are given herein with respect to resolution, and any other suitable resolution may be configured as needed in practical applications. In addition, the number of optional resolutions is also configurable.

Correspondingly, for image data 204-1, the terminal device 110 may determine the sampling strategy for image A is to downsample image A to 1080P (as shown by 221-3 in FIG. 2B) from multiple resolutions of 480P (as shown by 221-1 in FIG. 2B), 720P (as shown by 221-2 in FIG. 2B), 1080P (as shown by 221-3 in FIG. 2B), and 1440P (as shown by 221-4 in FIG. 2B), based on the query request 202 (for example, what content is included in image A), by using the trained machine learning model 114-1.

Subsequently, the terminal device 110 may send the sampling strategy as an instruction to the image sampling unit 205-1. Correspondingly, after receiving the instruction, the image sampling unit 205-1 may downsample the received image A to 1080P (as shown by 221-3 in FIG. 2B). The terminal device 110 sends the downsampled 1080p image obtained through the image sampling unit 205-1 and the query request 202 to the machine learning model 206. Subsequently, the terminal device 110 receives a reply 224 (for example, image A includes a certain object) for the query request determined via the machine learning model 206.

Referring to the example architecture 200C shown in FIG. 2C, it is described that the terminal device 110 determines a reply to the query request with the scenario where the query data 204 is of a sensor measurement data type. When the query data 204 includes image data of the image type or video data of the video type, the plurality of sampling frequencies used to determine the sampling strategy of the sensor measurement data 204-2 may include sampling frequencies such as 100 Hz (as shown by 231-1 in FIG. 2C), 250 Hz (as shown by 231-2 in FIG. 2C), 500 Hz (as shown by 231-3 in FIG. 2C), 1000 Hz (as shown by 231-4 in FIG. 2C), and the like. Of course, it should be understood that only several examples of sampling frequencies are given here, and any other suitable sampling frequency may be configured as needed in practical applications. In addition, the number of optional sampling frequencies is also configurable.

Accordingly, for the sensor measurement data 204-2, the terminal device 110 may determine the sampling strategy for the sensor measurement data 204-2 is to downsample the sensor measurement data 204-2 to 500 Hz (as shown by 231-3 in FIG. 2C) from the plurality of sampling frequencies 100 Hz (as shown by 231-1 in FIG. 2C), 250 Hz (as shown by 231-2 in FIG. 2C), 500 Hz (as shown by 231-3 in FIG. 2C), and 1000 Hz (as shown by 231-4 in FIG. 2C), based on the query request 202 (e.g., what gesture of user A indicates) by using the trained machine learning model 114-2.

Subsequently, the terminal device 110 may send the sampling strategy as an instruction to the sensor sampling unit 205-2. Correspondingly, after receiving the instruction, the sensor sampling unit 205-2 may downsample the received sensor measurement data 204-2 to 500 Hz (as shown by 231-3 in FIG. 2C). The terminal device 110 sends the downsampled 500 Hz sensor measurement data obtained via the sensor sampling unit 205-2 and the query request 202 to the machine learning model 206. Subsequently, the terminal device 110 receives a reply 234 for the query request determined via the machine learning model 206 (e.g., the gesture of the user A indicating to the right).

Referring to the example architecture 200D shown in FIG. 2D, it is described that the terminal device 110 determines a reply to the query request with the scenario where the query data 206 is of the audio type. When the query data 204 includes audio data of the audio type, the plurality of sampling frequencies used to determine the sampling strategy of the audio data 204-3 may include sampling frequencies, such as 48 kHz (as shown by 241-1 in FIG. 2D), 22.05 kHz (as shown by 241-2 in FIG. 2D), 16 kHz (as shown by 241-3 in FIG. 2D), 8kHz (as shown by 241-4 in FIG. 2D), and so on. Of course, it should be understood that only several examples of sampling frequencies are given here, and any other suitable sampling frequency may be configured as needed in practical applications. In addition, the number of optional sampling frequencies is also configurable.

Correspondingly, for the audio data 204-3, the terminal device 110 may determine the sampling strategy for the audio data 204-3 is to downsample audio data 204-3 to 22.05 kHz (as shown by 241-2 in FIG. 2D) from the plurality of sampling frequencies 48 kHz (as shown by 241-1 in FIG. 2D), 22.05 kHz (as shown by 241-2 in FIG. 2D), 16 kHz (as shown by 241-3 in FIG. 2D), and 8kHz (as shown by 241-4 in FIG. 2D), based on query request 202 (e.g., converting audio A to text), by using the trained machine learning model 114-3.

Subsequently, the terminal device 110 may send the sampling strategy as an instruction to the audio sampling unit 205-3. Correspondingly, after receiving the instruction, the audio sampling unit 205-3 may downsample the received audio data 204-3 to 22.05 kHz (as shown by 241-2 in FIG. 2D). The terminal device 110 sends the downsampled 22.05 kHz audio obtained through the audio sampling unit 205-3 and the query request 202 to the machine learning model 206. Subsequently, the terminal device 110 receives a reply 243 for the query request determined via the machine learning model 206.

Therefore, the present disclosure adopts different sampling strategies for different types of query data, so that the processing efficiency of the machine learning model can be optimized, thereby reducing the device energy consumption. Furthermore, the reply speed of the machine learning model for the query request of the user can be improved, thereby enhancing the user experience.

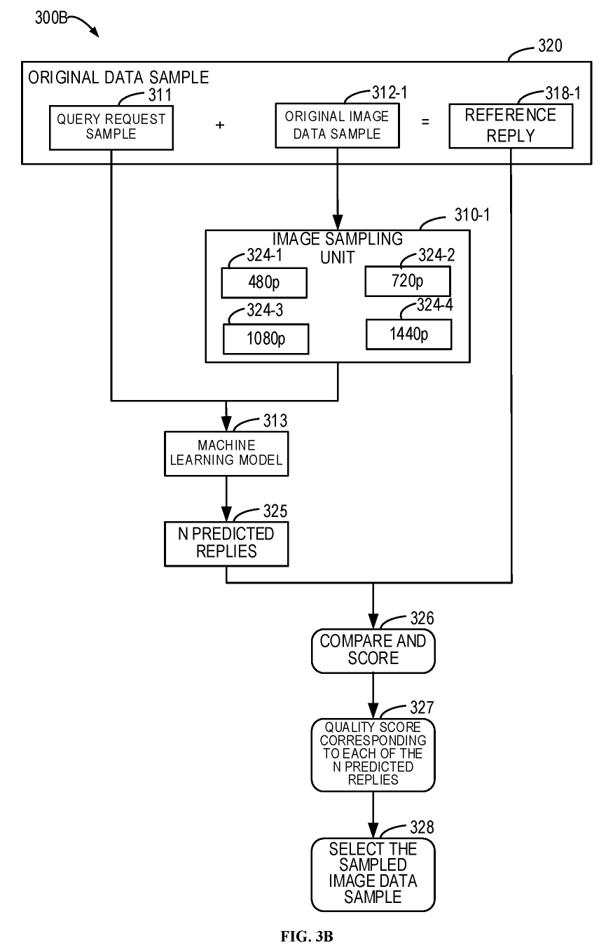

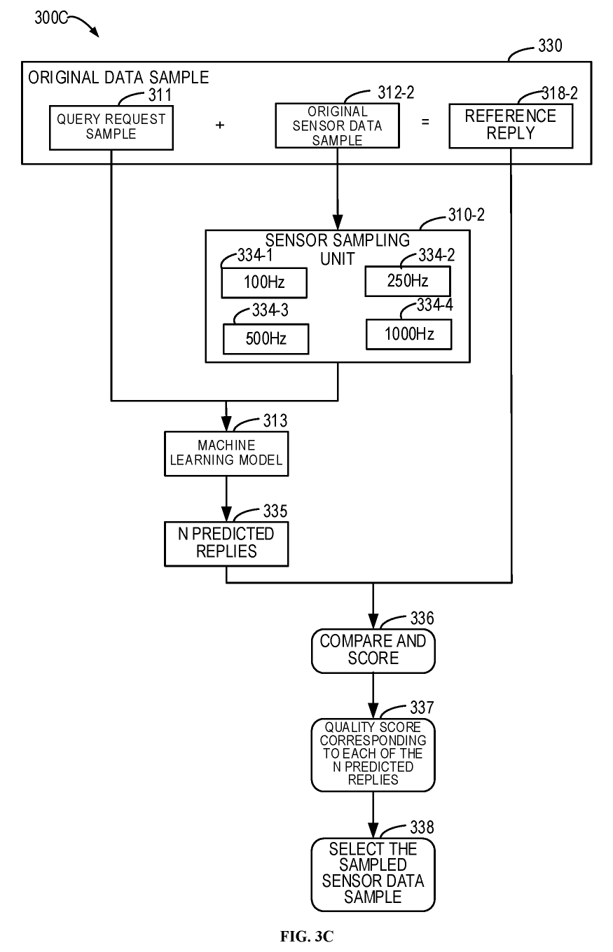

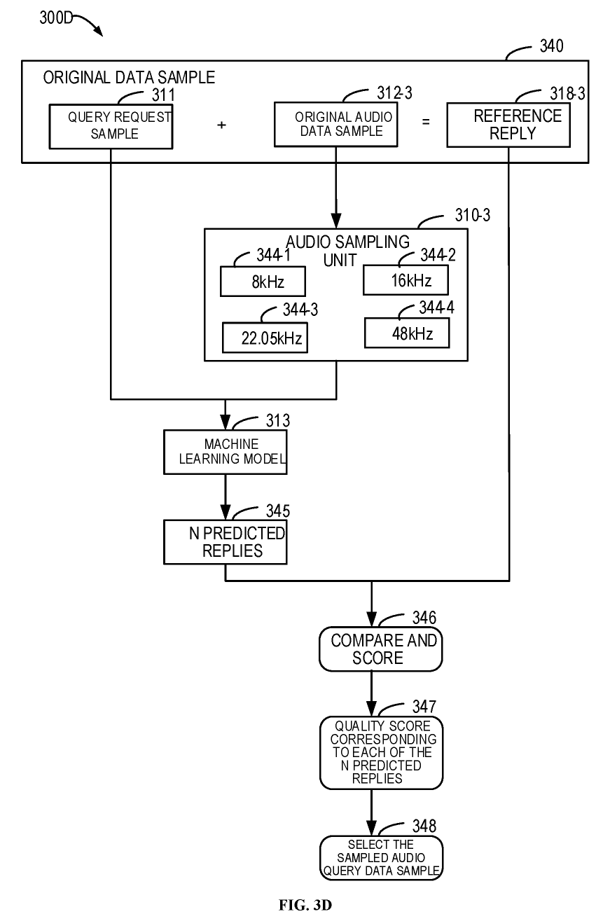

The application of the machine learning model 114 is described above in connection with FIGS. 2A-2D, and the process of obtaining the dataset for training the machine learning model 114 is described below with reference to FIGS. 3A to 3D. FIGS. 3A-3D illustrate schematic diagrams of example architectures 300A-300D for obtaining the dataset for training a machine learning model in accordance with some embodiments of the present disclosure. It should be noted that the machine learning model 114 may be trained at the terminal device 110, the server device 120, or any other suitable electronic device. Herein, it is merely illustrative to describe the training of the machine learning model 114 at the terminal device 110.

In some embodiments, the terminal device 110 may train the machine learning model 114 based on the training dataset. The training dataset may include a plurality of training samples, and each training sample includes a query request sample and a sampled query data sample. In some embodiments, the sampled query data sample is obtained by sampling the original query data sample by using one of a plurality of sampling strategies corresponding to the type of the query data sample. How the terminal device 110 creates a training dataset for training the machine learning model 114 is described below.

In some embodiments, during the process of creating the training dataset, the terminal device 110 may generate a plurality of corresponding training samples using the plurality of query request samples. For the query request sample, each training sample includes a query data sample obtained by sampling the original query data sample under a specific sampling strategy. This sampling strategy is considered more appropriate for the current query request sample, and can reduce the data amount of the query data while ensuring the accuracy of the final generated reply.

Referring to FIG. 3A, when creating the training dataset, the terminal device 110 first obtains the query request sample 311 and the original query data sample 312. In some embodiments, the query request sample 311 may include a text query request. In some embodiments, the terminal device 110 samples the original query data sample separately, by using the plurality of sampling strategies corresponding to the type of the original query data sample, to obtain a plurality of sampled candidate query data samples.

As shown in FIG. 3A, the terminal device 110 may determine a plurality of sampling strategies 311-1, 311-2,··· 311-N (collectively or individually referred to as sampling strategie 311) corresponding to the original query data sample of the given type. In some examples, the plurality of sampling strategies corresponding to each type of original query data sample may be preconfigured by the user. Subsequently, the terminal device 110 may invoke the sampling unit 310 to sample the original query data samples of the given type separately, based on the plurality of sampling strategies 311-1, 311-2,··· 311-N, to obtain a plurality of sampled candidate query data samples.

Correspondingly, for each of the plurality of candidate query data samples, the terminal device 110 determines, based on the query request sample and the candidate query data sample, a predicted reply for the query request using a trained third machine learning model. In some examples, for each of the plurality of candidate query data samples, the terminal device 110 may transmit the query request sample 311 and the candidate query data sample to the trained machine learning model 313 (referred to as a “third machine learning model”). Subsequently, the terminal device 110 obtains N predicted reply 314 for the query request 311 determined via the machine learning model 313. In some examples, the machine learning model 313 may be a trained machine learning model 130, or other machine learning model different from the machine learning model 130, capable of determining an accurate model output based on the model input.

Furthermore, the terminal device 110 determines respective quality scores of a plurality of predicted replies corresponding to the plurality of candidate query data samples. In some embodiments, the terminal device 110 may determine, based on the query request sample and the original query data sample, the reference reply for the query request sample using the machine learning model 130. Then, the terminal device 110 determines respective quality scores of the plurality of predicted replies based on a difference between the plurality of predicted replies and the reference reply.

As shown in the example framework 300A shown in FIG. 3A, the terminal device 110 may obtain the reference replay 318 by invoking the machine learning model 313 based on the query request sample 311 and the original query data sample 312. It may be understood that the terminal device 110 obtains the reference reply 318 based on the query request of the user 140 and the original query data sample 312 that is not be downsampled. At block 315, the terminal device 110 may compare the N predicted replies 314 with the reference reply 318. At block 316, the terminal device 110 determines respective quality scores of the N predicted replies based on the difference between the N predicted replies 314 and the reference reply 318. In some examples, the terminal device 110 may determine the difference between the N predicted replies 314 and the reference reply 318 via semantic similarity. For example, the terminal device 110 determines the difference between the N predicted replies 314 and the reference reply 318 based on similarity between average values/weighted values of text vectors.

The terminal device 110 may determine the difference between the N predicted replies 314 and the reference reply 318 by using a set comparison. For example, the terminal device 110 determines the difference between the N predicted replies 314 and the reference reply 318 based on whether the predicted reply and the reference reply belong to a correct set. The terminal device 110 may also determine the difference between the N predicted replies 314 and the reference reply 318 via character string matching. The terminal device 110 may also determine the difference between the N predicted replies 314 and the reference reply 318 by using accuracy.

In some embodiments, the terminal device 110 selects, from the plurality of candidate query data samples, the sampled query data sample corresponding to the query request sample, based on the respective quality scores of the plurality of predicted replies. At block 317, the terminal device 110 determines a predicted reply with a higher quality score (such as predicted reply A) from the N predicted replies 314, based on the respective quality scores of the N predicted replies 314. Furthermore, the terminal device 110 may use the training samples corresponding to predicted reply A as training samples for training the machine learning model 114.

The present disclosure samples the original query data samples separately, by using the plurality of sampling strategies, to obtain the plurality of sampled candidate query data samples. In this way, the training samples in the training dataset may cover the plurality of sampling strategies. By using such training dataset, training samples corresponding to different sampling strategies may be obtained, enabling the second machine learning model to learn that appropriate sampling strategies are determined for different query requests.

For ease of understanding, the following describes that the terminal device 110 creates the training dataset for training the machine learning model in conjunction with FIGS. 3B-3D and with some examples.

Referring to the example architecture 300B shown in FIG. 3B, it is described that the terminal device 110 creates the training dataset with the scenario where the original query data sample is of an image type. In this case, the plurality of resolutions of the query data samples of the image type/video type may include 480P (as shown by 324-1 in FIG. 3B), 720P (as shown by 324-2 in FIG. 3B), 1080P (as shown by 324-3 in FIG. 3B), 1440P (as shown by 324-4 in FIG. 3B), and the like. In some examples, the user may set the original resolution of the image of each sample to be a upper limit resolution of this set of training data, and gradually reduce the resolution in multiple stages. The terminal device 110 may invoke the image sampling unit 310-1 to sample the original image data sample 312-1 separately, based on the plurality of resolutions such as 480P (as shown by 324-1 in FIG. 3B), 720P (as shown by 324-2 in FIG. 3B), 1080P (as shown by 324-3 in FIG. 3B), and 1440P (as shown by 324-4 in FIG. 3B), to obtain a sampled candidate query data sample A, a candidate query data sample B, a candidate query data sample C, and a candidate query data sample D.

Correspondingly, the terminal device 110 sends, to the machine learning model 313, the candidate query data sample A, the candidate query data sample B, the candidate query data sample C, the candidate query data sample D obtained by the image sampling unit 310-1, and the query request sample 311 respectively. The terminal device 110 receives N predicted replies 325 for the query request sample 311 determined via the machine learning model 313, for example, predicted reply A corresponding to the sampled candidate query data sample A, predicted reply B corresponding to the sampled candidate query data sample B, predicted reply C corresponding to the sampled candidate query data sample C, and predicted reply D corresponding to the sampled candidate query data sample D.

Subsequently, the terminal device 110 may obtain the reference reply 318-1 based on the query request sample 311 and the original image data sample 312-1, by invoking the machine learning model 313. At block 326, the terminal device 110 may compare the N predicted replies 325 with the reference reply 318-1. At block 327, the terminal device 110 determines respective quality scores of the predicted reply A , the predicted reply B, the predicted reply C, and the predicted reply D, based on the difference between the N predicted replies 325 and the reference reply 318-1. At block 328, the terminal device 110 determines a predicted reply with a higher quality score (such as the predicted reply C) of the N predicted replies 325, based on the respective quality scores of the N predicted replies 325. Furthermore, the terminal device 110 may use the 1080p image corresponding to the predicted reply C, the query request sample 311, and the reference reply 318-1 as training samples for training the machine learning model 114.

Referring to the example architecture 300C shown in FIG. 3C, it is described that the terminal device 110 creates the training dataset with the scenario where the original query data sample is of a sensor measurement data type. In this case, the plurality of sampling frequencies of the query data samples of the sensor measurement data type include 100 Hz (as shown by 334-1 in FIG. 3C), 250 Hz (as shown by 334-2 in FIG. 3C), 500 Hz (as shown by 334-3 in FIG. 3C), 1000 Hz (as shown by 334-4 in FIG. 3C), and on the like. In some examples, the user may set an original hertz (Hz) of IMU in each sample to be the upper limit hertz (Hz) of this set of data, and gradually decrease hertz (Hz) in multiple stages. The terminal device 110 may invoke a sensor sampling unit 310-2 to sample the original sensor data samples 312-2 separately, based on the plurality of sampling frequencies of 100 Hz (as shown by 334-1 in FIG. 3C), 250 Hz (as shown by 334-2 in FIG. 3C), 500 Hz (as shown by 334-3 in FIG. 3C), and 1000 Hz (as shown by 334-4 in FIG. 3C), to obtain sampled candidate query data sample AA, candidate query data sample BB, candidate query data sample CC, and candidate query data sample DD.

Correspondingly, the terminal device 110 sends, to the machine learning model 313, the candidate query data sample AA, the candidate query data sample BB, the candidate query data sample CC, the candidate query data sample DD obtained via the sensor sampling unit 310-2, and the query request sample 311, respectively. The terminal device 110 receives N predicted replies 335 for the query request sample 311 determined via the machine learning model 313, for example, the predicted reply AA corresponding to the sampled candidate query data sample AA, the predicted reply BB corresponding to the sampled candidate query data sample BB, the predicted reply CC corresponding to the sampled candidate query data sample CC, and the predicted reply DD corresponding to the sampled candidate query data sample A.

Subsequently, the terminal device 110 may obtain the reference reply 318-2 based on the query request sample 311 and the original sensor data sample 312-2, by invoking the machine learning model 313. At block 336, the terminal device 110 may compare the N predicted replies 335 with the reference reply 318-2. At block 337, the terminal device 110 determines respective quality scores of the predicted reply AA, the predicted reply BB, the predicted reply CC, and the predicted reply DD based on the difference between the N predicted replies 335 and the reference reply 318-2. At block 338, the terminal device 110 determines a predicted reply with a higher quality score (such as predicted reply CC ) of the N predicted replies 335 based on the respective quality scores of the N predicted replies 335. Furthermore, the terminal device 110 may use 500 Hz corresponding to the predicted reply CC, the query request sample 311, and the reference reply 318-2 as training samples for training the machine learning model 114.

Referring to the example architecture 300D shown in FIG. 3D, it is described that the terminal device 110 creates the training dataset with the scenario where the original query data sample is of an audio type. In this case, the plurality of sampling frequencies of the query data samples of the audio type may include 48 kHz (as shown by 344-1 in FIG. 3D), 22.05 kHz (as shown by 344-2 in FIG. 3D), 16 kHz (as shown by 344-3 in FIG. 3D), and 8kHz (as shown by 344-4 in FIG. 3D). In some examples, the user may set the original Hertz (Hz) of the audio in each sample to be the upper limit Hertz (Hz) of this set of training data and gradually decrease Hertz (Hz) at multiple stages. The terminal device 110 may invoke the audio sampling unit 310-3 to sample the original audio data samples 312-3 separately, based on the plurality of sampling frequencies 48 kHz (as shown by 344-1 in FIG. 3D), 22.05 kHz (as shown by 344-2 in FIG. 3D), and 16 kHz (as shown by 344-3 in FIG. 3D) and 8kHz (as shown by 344-4 in FIG. 3D), to obtain sampled candidate query data sample E, candidate query data sample F, candidate query data sample G, and candidate query data sample H.

Correspondingly, the terminal device 110 sends, to the machine learning model 313, the candidate query data sample E, the candidate query data sample F, the candidate query data sample G, the candidate query data sample H obtained via the audio sampling unit 310-3, and the query request sample 311 separately. The terminal device 110 receives N predicted reply 345 for the query request sample 311 determined via the machine learning model 313, for example, the predicted reply E corresponding to the sampled candidate query data sample E, the predicted reply F corresponding to the sampled candidate query data sample F, the predicted reply G corresponding to the sampled candidate query data sample G, and the predicted reply H corresponding to the sampled candidate query data sample H.

Subsequently, the terminal device 110 may obtain the reference reply 318-3 based on the query request sample 311 and the original audio data sample 312-3, by invoking the machine learning model 313. At block 346, the terminal device 110 may compare the N predicted replies 345 with the reference reply 318-3. At block 347, the terminal device 110 determines respective quality scores of the predicted reply E, the predicted reply F, the predicted reply G, and the predicted reply H, based on the difference between the N predicted replies 345 and the reference reply 318-3. At block 348, the terminal device 110 determines a predicted reply with a higher quality score (such as predicted reply G) of the N predicted replies 345, based on the respective quality scores of the N predicted replies 345. Furthermore, the terminal device 110 may use 22.05 kHz corresponding to the predicted reply G, the query request sample 311, and the reference reply 318-3 as training samples for training the machine learning model 114.

The training samples in the training dataset obtained in this way may cover the plurality of sampling strategies. By using such training dataset, training samples corresponding to different sampling strategies can be obtained, enabling the second machine learning model to learn that appropriate sampling strategies are determined for different query requests.

In some embodiments, the terminal device 110 trains the machine learning model 114 based on the created training dataset for providing replies to the query requests of the user. In some examples, due to the large size of the machine learning model 114 trained on a large number of training datasets, it is difficult to directly use the machine learning model 114 as a local small model. Therefore, the terminal device 110 may also miniaturize the machine learning model 114 (i.e., knowledge distillation and model pruning), to make the compressed model lighter and more efficient in inference while retaining the performance of the machine learning model 114. Furthermore, the terminal device 110 may also fine tune the distilled machine learning model by using some data in the training dataset, to further maintain the miniaturized model performance, thereby improving the expressive power of the model.

In summary, according to various embodiments of the present disclosure, different sampling strategies for different types of query data may be determined by using the trained machine learning models, so that the processing efficiency of the machine learning model can be optimized, and the device energy consumption can be reduced. Furthermore, according to the embodiments of the present disclosure, the understanding capability and reply quality of the machine learning model can be enhanced while improving the reply speed of the machine learning model to the query requests of the user, thereby improving the user experience.

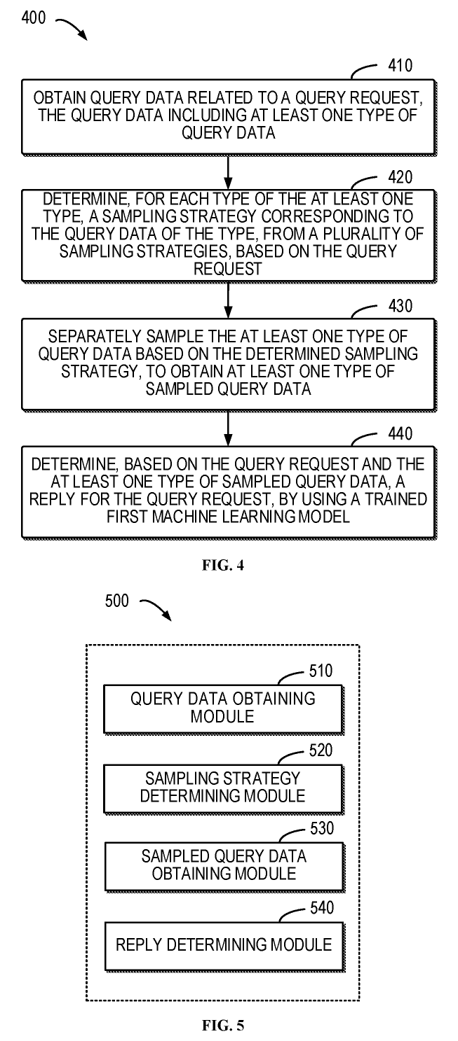

FIG. 4 illustrates a flowchart of a method 400 for request processing according to some embodiments of the present disclosure. The method 400 may be implemented at the terminal device 110.

At block 410, the terminal device 110 obtains query data related to a query request, the query data including at least one type of query data.

At block 420, the terminal device 110 determines, for each type of the at least one type, a sampling strategy corresponding to the query data of the type, from a plurality of sampling strategies, based on the query request.

At block 430, the terminal device 110 separately samples the at least one type of query data based on the determined sampling strategy, to obtain at least one type of sampled query data.

At block 440, the terminal device 110 determines, based on the query request and the at least one type of sampled query data, a reply for the query request, by using a trained first machine learning model.

In some embodiments, the at least one type includes one or more of: an image type, a video type, an audio type, and a measurement data type.

In some embodiments, the query data includes image data of an image type or video data of a video type, and the plurality of sampling strategies indicate a plurality of resolutions; and/or the query data includes audio data of an audio type or measurement data of a sensor measurement data type, and the plurality of sampling strategies indicate a plurality of sampling frequencies.

In some embodiments, determining the sampling strategy corresponding to the query data of the type from a plurality of sampling strategies comprises: determining, based on the query request, a sampling strategy corresponding to the query data of the type, from the plurality of sampling strategies by using a trained second machine learning model.

In some embodiments, the process 400 is implemented at the terminal device, and the second machine learning model is deployed locally on the terminal device.

In some embodiments, the second machine learning model is obtained by training based on a training dataset, the training dataset includes a plurality of training samples, each of the training samples includes a query request sample and a sampled query data sample, and the sampled query data sample is obtained by sampling an original query data sample using one of the plurality of sampling strategies corresponding to a type of the query data sample.

In some embodiments, the training samples in the training dataset are trained by: sampling the original query data sample by separately using a plurality of sampling strategies corresponding to a type of the original query data sample, to obtain a plurality of sampled candidate query data samples; determining, for each candidate query data sample of the plurality of candidate query data samples, a predicted reply for the query request sample, by using a trained third machine learning model, based on the query request sample and the candidate query data sample; determining respective quality scores of a plurality of predicted replies corresponding to the plurality of candidate query data samples; and selecting, based on the respective quality scores of the plurality of predicted replied, a sampled query data sample corresponding to the query request sample, from the plurality of candidate query data samples.

In some embodiments, determining the respective quality scores of the plurality of predicted replies corresponding to the plurality of candidate query data samples comprises: determining, based on the query request sample and the original query data sample, a reference reply for the query request sample, by using the first machine learning model; and determining the respective quality scores of the plurality of predicted replies based on a difference between the plurality of predicted replies and the reference replies.

In some embodiments, determining the sampling strategy corresponding to the query data of the type, from a plurality of sampling strategies comprises: for a given type of the at least one type, determining a second machine learning model corresponding to the given type; and determining, based on the query request, a sampling strategy corresponding to the query data of the given type, from the plurality of sampling strategies of the given type, by using the determined second machine learning model.

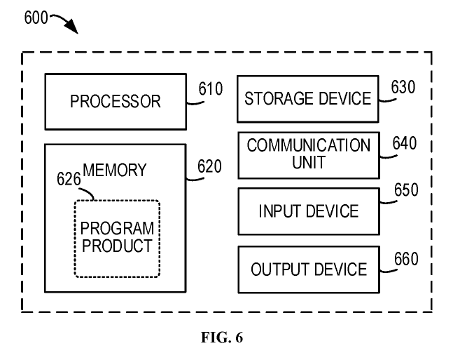

Embodiments of the present disclosure also provide a corresponding apparatus for implementing the above method or process. FIG. 5 illustrates a schematic structural block diagram of an apparatus 500 for request processing according to some embodiments of the present disclosure. The apparatus 500 may be implemented or included in the terminal device 110. Various modules/components in the apparatus 500 may be implemented by hardware, software, firmware, or any combination thereof.

As shown in FIG. 5, the apparatus 500 includes a query data obtaining module 510 configured to obtain query data related to a query request, the query data including at least one type of query data. The apparatus 500 further includes a sampling strategy determining module 520 configured to determine, for each type of the at least one type, a sampling strategy corresponding to the query data of the type, from a plurality of sampling strategies, based on the query request. The apparatus 500 further includes a sampled query data obtaining module 530 configured to separately sample the at least one type of query data based on the determined sampling strategy, to obtain at least one type of sampled query data. The apparatus 500 further includes a reply determining module 540 configured to determine, based on the query request and the at least one type of sampled query data, a reply for the query request by using a trained first machine learning model.

In some embodiments, the at least one type includes one or more of: an image type, a video type, an audio type, and a measurement data type.

In some embodiments, the query data includes image data of an image type or video data of a video type, and the plurality of sampling strategies indicate a plurality of resolutions; and/or the query data includes audio data of an audio type or measurement data of a sensor measurement data type, and the plurality of sampling strategies indicate a plurality of sampling frequencies.

In some embodiments, determining the sampling strategy corresponding to the query data of the type, from the plurality of sampling strategies includes: determining, based on the query request, a sampling strategy corresponding to the query data of the type, from the plurality of sampling strategies, by using a trained second machine learning model.

In some embodiments, the apparatus 500 is implemented at a terminal device, and the second machine learning model is deployed locally on the terminal device.

In some embodiments, the second machine learning model is obtained by training based on a training dataset, the training dataset includes a plurality of training samples, each of the training samples include a query request sample and a sampled query data sample, the sampled query data sample is obtained by sampling an original query data sample using one of the plurality of sampling strategies corresponding to a type of the query data sample.

In some embodiments, the training samples in the training dataset are trained by: sampling the original query data sample by separately using a plurality of sampling strategies corresponding to a type of the original query data sample, to obtain a plurality of sampled candidate query data samples; determining, for each candidate query data sample of the plurality of candidate query data samples, a predicted reply for the query request sample, by using a trained third machine learning model, based on the query request sample and the candidate query data sample; determining respective quality scores of a plurality of predicted replies corresponding to the plurality of candidate query data samples; and selecting, based on the respective quality scores of the plurality of predicted replies, a sampled query data sample corresponding to the query request sample, from the plurality of candidate query data samples.

In some embodiments, the apparatus 500 further includes a quality score determining module configured to determine, based on the query request sample and the original query data sample, a reference reply for the query request sample, by using the first machine learning model; and determine the respective quality scores of the plurality of predicted replies based on a difference between the plurality of predicted replies and the reference replies.

In some embodiments, the sampling strategy determining module 520 is further configured to, for a given type of the at least one type, determine a second machine learning model corresponding to the given type; and determine, based on the query request, a sampling strategy corresponding to the query data of the given type, from the plurality of sampling strategies of the given type, by using the determined second machine learning model.

The modules included in the apparatus 500 may be implemented in various manners, including software, hardware, firmware, or any combination thereof. In some embodiments, one or more modules may be implemented using software and/or firmware, such as machine executable instructions stored on a storage medium. In addition to or as an alternative to machine executable instructions, some or all of the modules in the apparatus 500 may be implemented at least partially by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of steps in the above methods may be performed by a suitable electronic device or a combination of electronic devices. Such an electronic device or a combination of electronic devices may include, for example, the terminal device 110 in FIG. 1.

FIG. 6 illustrates a block diagram of an example electronic device 600 in which one or more embodiments of the present disclosure may be implemented. It should be understood that the electronic device 600 illustrated in FIG. 6 is merely illustrative and should not constitute any limitation on the functionality and scope of the embodiments described herein. The electronic device 600 shown in FIG. 6 may be used to implement the terminal device 110 in FIG. 1 or the apparatus 500 in FIG. 5.

As shown in FIG. 6, the electronic device 600 is in the form of a general-purpose electronic device. The components of the electronic device 600 may include, but are not limited to, one or more processors or processing units 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processing units execute computer-executable instructions in parallel to improve parallel processing capabilities of electronic device 600.

The electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices are such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to the example implementations of the present disclosure, a computer-readable storage medium is provided, on which computer-executable instructions or a computer program is stored, where the computer-executable instructions are executed by a processor to implement the method described above. According to the example implementations of the present disclosure, a computer program product is further provided. The computer program product is tangibly stored on a non-transitory computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, specialized computers, or other programmable data processing devices to produce a machine that generates an apparatus to implement the functions/actions specified in one or more blocks in the flow chart and/or the block diagram when these instructions are executed through the computer or other programmable data processing apparatuses. These computer-readable program instructions may also be stored in a computer-readable storage medium. These instructions enable a computer, a programmable data processing apparatus and/or other devices to work in a specific way. Therefore, the computer-readable medium storing the instructions includes an article of manufacture, which includes instructions to implement various aspects of the functions/actions specified in one or more blocks in the flowchart and/or the block diagram.

The computer-readable program instructions may be loaded onto a computer, other programmable data processing apparatus, or other devices, so that a series of operational steps may be executed on a computer, other programmable data processing apparatus, or other devices, to generate a computer-implemented process, such that the instructions which execute on a computer, other programmable data processing apparatuses, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a module, program segment, or a part of instructions, which contains one or more executable instructions for implementing the specified logic function. In some alternative implementations, the functions labeled in the block may also occur in a different order from those labeled in the drawings. For example, two consecutive blocks may actually be executed in parallel, and sometimes can also be executed in a reverse order, depending on the functionality involved. It should also be noted that each block in the block diagram and/or the flowchart, and combinations of blocks in the block diagram and/or the flowchart, may be implemented by a dedicated hardware-based system that executes the specified functions or acts, or by the combination of dedicated hardware and computer instructions.

Each implementation of the present disclosure has been described above. The above description is an example, not exhaustive, and is not limited to the disclosed implementations. Without departing from the scope and spirit of the described implementations, many modifications and changes are obvious to those of ordinary skill in the art. The selection of terms used in the present disclosure aims to best explain the principles, practical application or improvement of technology in the market of each implementation, or to enable others of ordinary skill in the art to understand the various implementations disclosed herein.

I/We Claim:

1. A method of request processing, comprising:
obtaining query data related to a query request, the query data including at least one type of query data;
determining, for each type of the at least one type, a sampling strategy corresponding to the query data of the type, from a plurality of sampling strategies, based on the query request;
separately sampling the at least one type of query data based on the determined sampling strategy, to obtain at least one type of sampled query data; and
determining, based on the query request and the at least one type of sampled query data, a reply for the query request, by using a trained first machine learning model.

2. The method of claim 1, wherein the at least one type includes one or more of: an image type, a video type, an audio type, a measurement data type.

3. The method of claim 2, wherein the query data includes image data of an image type or video data of a video type, and the plurality of sampling strategies indicate a plurality of resolutions; and/or
wherein the query data includes audio data of an audio type or measurement data of a sensor measurement data type, and the plurality of sampling strategies indicate a plurality of sampling frequencies.

4. The method of claim 1, wherein determining the sampling strategy corresponding to the query data of the type, from a plurality of sampling strategies comprises:
determining, based on the query request, a sampling strategy corresponding to the query data of the type, from a plurality of sampling strategies, by using a trained second machine learning model.

5. The method of claim 4, wherein the method is implemented at a terminal device, and wherein the second machine learning model is deployed locally on the terminal device.

6. The method of claim 1, wherein the second machine learning model is obtained by training based on a training dataset, the training dataset including a plurality of training samples, each of the training samples including a query request sample and a sampled query data sample, the sampled query data sample being obtained by sampling an original query data sample using one of the plurality of sampling strategies corresponding to a type of the query data sample.

7. The method of claim 6, wherein the training samples in the training dataset are trained by:
sampling the original query data sample by separately using a plurality of sampling strategies corresponding to a type of the original query data sample, to obtain a plurality of sampled candidate query data samples;
determining, for each candidate query data sample of the plurality of candidate query data samples, a predicted reply for the query request sample, by using a trained third machine learning model, based on the query request sample and the candidate query data sample;
determining respective quality scores of a plurality of predicted replies corresponding to the plurality of candidate query data samples; and
selecting, based on the respective quality scores of the plurality of predicted replies, a sampled query data sample corresponding to the query request sample, from the plurality of candidate query data samples.

8. The method of claim 7, wherein determining the respective quality scores of the plurality of predicted replies corresponding to the plurality of candidate query data samples comprises:
determining, based on the query request sample and the original query data sample, a reference reply for the query request sample, by using the first machine learning model; and
determining the respective quality scores of the plurality of predicted replies based on a difference between the plurality of predicted replies and the reference replies.

9. The method of claim 1, wherein determining the sampling strategy corresponding to the query data of the type, from a plurality of sampling strategies comprises: for a given type of the at least one type,
determining a second machine learning model corresponding to the given type; and
determining, based on the query request, a sampling strategy corresponding to the query data of the given type, from a plurality of sampling strategies of the given type, by using the determined second machine learning model.

10. An electronic device comprising:
at least one processor; and
at least one memory coupled to the at least one processor and storing instructions for execution by the at least one processor, the instructions, when executed by the at least one processor, causing the electronic device to perform operations comprising:
obtaining query data related to a query request, the query data including at least one type of query data;
determining, for each type of the at least one type, a sampling strategy corresponding to the query data of the type, from a plurality of sampling strategies, based on the query request;
separately sampling the at least one type of query data based on the determined sampling strategy, to obtain at least one type of sampled query data; and
determining, based on the query request and the at least one type of sampled query data, a reply for the query request, by using a trained first machine learning model.

11. The electronic device of claim 10, wherein the at least one type includes one or more of: an image type, a video type, an audio type, a measurement data type.

12. The electronic device of claim 11, wherein the query data includes image data of an image type or video data of a video type, and the plurality of sampling strategies indicate a plurality of resolutions; and/or
wherein the query data includes audio data of an audio type or measurement data of a sensor measurement data type, and the plurality of sampling strategies indicate a plurality of sampling frequencies.

13. The electronic device of claim 10, wherein determining the sampling strategy corresponding to the query data of the type, from a plurality of sampling strategies comprises:
determining, based on the query request, a sampling strategy corresponding to the query data of the type, from a plurality of sampling strategies, by using a trained second machine learning model.

14. The electronic device of claim 13, wherein the electronic device is implemented at a terminal device, and wherein the second machine learning model is deployed locally on the terminal device.

15. The electronic device of claim 14, wherein the second machine learning model is obtained by training based on a training dataset, the training dataset including a plurality of training samples, each of the training samples including a query request sample and a sampled query data sample, the sampled query data sample being obtained by sampling an original query data sample using one of the plurality of sampling strategies corresponding to a type of the query data sample.

16. The electronic device of claim 15, wherein the training samples in the training dataset are trained by:
sampling the original query data sample by separately using a plurality of sampling strategies corresponding to a type of the original query data sample, to obtain a plurality of sampled candidate query data samples;
determining, for each candidate query data sample of the plurality of candidate query data samples, a predicted reply for the query request sample, by using a trained third machine learning model, based on the query request sample and the candidate query data sample;
determining respective quality scores of a plurality of predicted replies corresponding to the plurality of candidate query data samples; and
selecting, based on the respective quality scores of the plurality of predicted replies, a sampled query data sample corresponding to the query request sample, from the plurality of candidate query data samples.

17. The electronic device of claim 16, wherein determining the respective quality scores of the plurality of predicted replies corresponding to the plurality of candidate query data samples comprises:
determining, based on the query request sample and the original query data sample, a reference reply for the query request sample, by using the first machine learning model; and
determining the respective quality scores of the plurality of predicted replies based on a difference between the plurality of predicted replies and the reference replies.

18. The electronic device of claim 10, wherein determining the sampling strategy corresponding to the query data of the type, from a plurality of sampling strategies comprises: for a given type of the at least one type,
determining a second machine learning model corresponding to the given type; and
determining, based on the query request, a sampling strategy corresponding to the query data of the given type, from a plurality of sampling strategies of the given type, by using the determined second machine learning model.

19. A non-transitory computer readable storage medium having stored thereon a computer program executable by a processor to implement opeartionscomprising:
obtaining query data related to a query request, the query data including at least one type of query data;
determining, for each type of the at least one type, a sampling strategy corresponding to the query data of the type, from a plurality of sampling strategies, based on the query request;
separately sampling the at least one type of query data based on the determined sampling strategy, to obtain at least one type of sampled query data; and
determining, based on the query request and the at least one type of sampled query data, a reply for the query request, by using a trained first machine learning model.

20. The non-transitory computer readable storage medium of claim 19, wherein the at least one type includes one or more of: an image type, a video type, an audio type, a measurement data type.
